(19) United States
(12) Patent Application Publication
(10) Pub. No.: US 2007/0111566 A1
(43) Pub. Date: May 17, 2007

(54) Elastomeric connector assembly

(75) Inventors: John Howard Seibert, Collegeville, PA (US); Edward Joseph Pupkiewicz, Lansdale, PA (US)

Correspondence Address: Robert J. Kapalka;Tyco Electronic Corporation, Suite 140, 4550 New Linden Hill Road, Wilmington, DE, 19808, US

(73) Assignee: Tyco Electronic Corporation

(21) Appl. No.: 11/281,665

(22) Filed: Nov. 17, 2005

(51) Int. Cl. H01R 4/58

(52) U.S. Cl. 439/91

(57) ABSTRACT

An electrical connector assembly includes an elastomeric member including a plurality of conductive elements that extend between first and second contact surfaces. The conductive elements form patterns on the first and second contact surfaces. One of the contact surfaces is configured to mate with an electronic module and the other of the contact surfaces is configured to mate with a circuit board. A holder is configured to be attached to the circuit board. The holder receives the elastomeric member, and is configured to receive and hold the electronic module securely against the elastomeric member to establish an electrical connection between the circuit board and the electronic module.

### BACKGROUND OF THE INVENTION

The invention relates generally to electrical connectors and, more particularly, to an elastomeric connector assembly for connecting an electronic module to a circuit board.

### BRIEF DESCRIPTION OF THE INVENTION

Electrical connectors are commonly used to interconnect circuit boards or to interconnect a circuit board with an electrical device. Traditional connector solutions utilize stamped and formed terminal contact designs that are soldered or press fit into the circuit boards. The size and shape of these traditional solutions is limited by the available technologies for forming the stamped and formed terminals. The increasing complexity of electronic assemblies combined with progressively smaller electronic packages has generated a need for smaller connector designs. Many electronic devices include add-on modules having their own circuit boards that are connected to a circuit board in the electronic device. However, some electronic modules, such as cameras, fingerprint recognition modules, speakers, and microphones, and the like, are sensitive to and would be damaged by the heat associated with soldering processes.

The aforementioned concerns have led to the increasing use of elastomeric connectors in electronic devices. One type of elastomeric connector includes alternating layers of a conductive and non-conductive elastomeric material such as silicon rubber, with the conductive layers formed with layers of silicon material impregnated with electrically conductive material such as carbon, gold, or silver, and the like. The non-conductive or dielectric elastomer layers are sandwiched between the conductive layers and are of sufficient thickness to insulate the conductive layers from one another. The elastomeric connector is compressively held between the circuit board and module to electrically interconnect conductive traces on the board and module.

Notwithstanding the opportunities associated with the use of elastomeric connectors, it remains a challenge to provide a low cost connector solution that is easily customized, with reduced tooling costs, thereby lowering manufacturing costs.

### BRIEF DESCRIPTION OF THE INVENTION

In one aspect, an electrical connector assembly is provided. The assembly includes an elastomeric member including a plurality of conductive elements that extend between first and second contact surfaces. The conductive elements form patterns on the first and second contact surfaces. One of the contact surfaces is configured to mate with an electronic module and the other of the contact surfaces is configured to mate with a circuit board. A holder is configured to be attached to the circuit board. The holder receives the elastomeric member, and is configured to receive and hold the electronic module securely against the elastomeric member to establish an electrical connection between the circuit board and the electronic module.

Optionally, the holder includes side walls having slots formed therein to form deflectable sections. The deflectable sections include a clip on an interior portion of the side wall to retain the module. Each conductive element includes a plurality of conductive layers and nonconductive layers in an alternating arrangement. The conductive and nonconductive layers extend between the first and second contact surfaces and are substantially perpendicular to the first and second contact surfaces. The electrical connection between the circuit board and the electronic module is established through the conductive elements. The elastomeric member further includes insulating sections extending between the first and second contact surfaces. An adhesive is applied only to the insulating sections at one of the contact surfaces to bond the elastomeric member to one of the circuit board and the electronic module.

In another aspect, an electronic assembly is provided. The assembly includes an electronic module having a mating surface. The mating surface includes a plurality of contact elements arranged in a pattern. An elastomeric member including a plurality of conductive elements extends between first and second contact surfaces. The conductive elements form patterns on the first and second contact surfaces. One of the contact surfaces is configured to mate with the electronic module and the other of the contact surfaces is configured to mate with a circuit board. A holder is configured to be attached to the circuit board. The holder receives the elastomeric member, and is configured to receive and hold the electronic module securely against the elastomeric member to establish an electrical connection between the circuit board and the electronic module.

### BRIEF DESCRIPTION OF THE DRAWINGS

FIG. 1 is an exploded view of an electronic assembly including a connector assembly formed in accordance with an exemplary embodiment of the present invention.

FIG. 2 is a perspective view of a circuit board of an electronic device.

FIG. 3 is a bottom perspective view of an electronic module with the elastomeric connector removed.

FIG. 4 is a perspective view of an elastomeric connector formed in accordance with an exemplary embodiment of the present invention.

FIG. 5 is a cross sectional view of one row of the connector shown in FIG. 4 along the line 5-5.

FIG. 6 is a perspective view of the electronic assembly shown in FIG. 1 in an assembled condition.

### DETAILED DESCRIPTION OF THE INVENTION

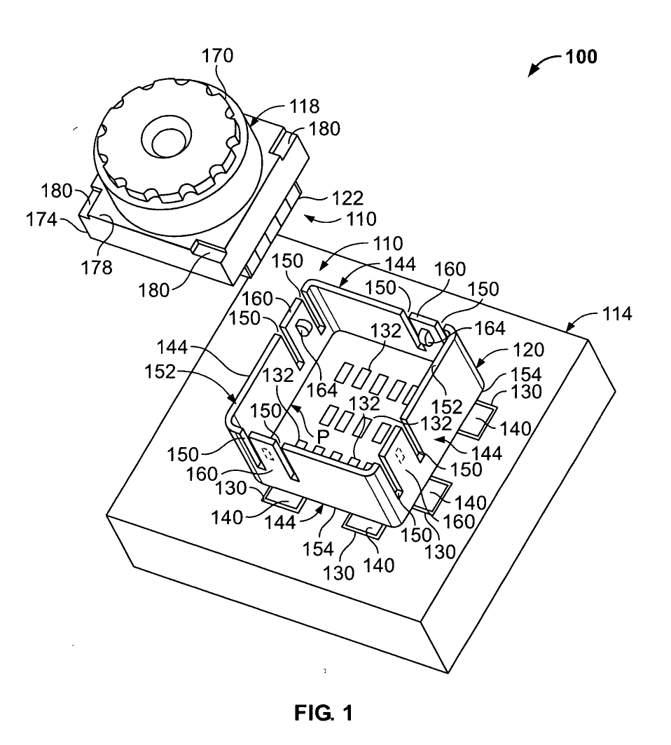

FIG. 1 is an exploded view of an electronic assembly 100 including a connector assembly 110 formed in accordance with an exemplary embodiment of the present invention. The electronic assembly includes a circuit board 114, the connector assembly 110, and an electronic module 118. The connector assembly 110 includes a holder 120 and an elastomeric connector 122 that, in FIG. 1, is attached to the electronic module 118. The electronic module 118 shown in FIG. 1 depicts a camera module that may be used in an electronic device such as a cellular phone and the invention will be described with reference to such a module. It is to be understood however that such description is for illustration purposes only and that the connector assembly 110 may be used with, and the benefits derived are applicable to, other types of electronic modules including, but not limited to, speakers, microphones, fingerprint recognition sensors, and the like.

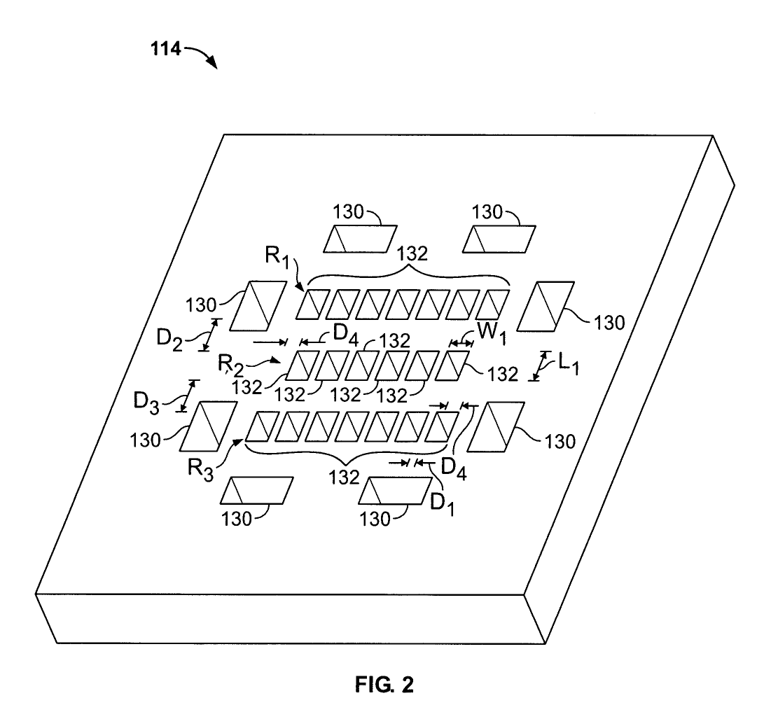

FIG. 2 is a perspective view of the circuit board 114. The circuit board 114 includes a number of footprints 130 that are provided for the holder 120, and a number of electrical contact padsl32 that form a contact pattern on the circuit board 114. The footprints 130 surround the contact pads 132 such that when the holder 120 is attached to the circuit board 114, the contact pads 132 will lie within a perimeter of the holder 120. In the embodiment shown in FIG. 2, the contact pads 132 are rectangular in shape and are of a uniform size wherein each contact pad 132 has a length L₁ and a width W₁. In other embodiments, the contact pads 132 may be non-uniform and may include a mix of differing sizes and shapes. The illustrated contact pads 132 are arranged in rows R₁, R₂, and R₃ and within each row, the pads 132 are uniformly spaced a distance D₁ apart. Rows R₁ and R₂ are spaced a distance D₂ apart and rows R₂ and R₃ are spaced apart a distance D₃ which may be the same or different from the distance D₂. Row R₂ is offset a distance D₄ from rows R₁ and R₃.

Returning to FIG. 1, the holder 120 includes a number of feet 140 that are placed on the footprints 130 on the circuit board 114. The holder 120 includes side walls 144 that form a holder perimeter P. The holder 120 is positioned on the circuit board 114 such that the contact pads 132 are surrounded by and lie within the perimeter P of the holder 120. In an exemplary embodiment, the holder 120 is stamped and formed from a metallic material and is attached to the circuit board 114 by reflow soldering to become an integral part of the circuit board 114. In alternative embodiments, the holder may be formed from other materials such as plastic (e.g. injection molded plastic) and attached to the circuit board 114 using known processes for the attachment of plastic materials. In addition, the holder 120 may provide shielding, if required, for the electronic module 118 from other components in the electronic device.

Each of the side walls 144 of the holder 120 include a pair of slots 150 that extend vertically from an upper edge 152 of the side walls 144 toward, but not completely to a bottom edge 154 of the side walls 144. The pairs of slots define a deflectable section 160 therebetween in each side wall 144. The deflectable sections 160 include a snap clip 164 formed therein. The snap clips 164 extend toward an interior of the holder 120 and engage the electronic module 118 when the electronic module 118 is inserted onto the holder 120 as will be described. The holder 120 is mechanically attached to the circuit board 114, but does not form a conductive part of the electrical circuits on either the circuit board 114 or the electronic module 118. The holder 120 is attached to the main circuit 114 board prior to receiving the electronic module 118 or the elastomeric connector 122 so that the electronic module 118 is not subjected to the heat associated with the reflow solder process when the holder 120 is soldered to the circuit board 114.

The electronic module 118 includes a device 170, such as a camera module, that is to be connected to the circuit board 114. In an exemplary embodiment, the electronic module 118 may itself also include a circuit board 174 to which the elastomeric connector 122 is adhered, such that the elastomeric connector 122 forms an integral part of the electronic module 118. The electronic module 118, including the elastomeric connector 122, is received in the holder 120. The electronic module 118 includes an upper surface 178. In one embodiment, the upper surface 178 includes engagement areas 180 that engage the snap clips 164 when the electronic module 118 is received in the holder 120. The holder 118 holds the electronic module 118 securely against, and in a conductive relation with, the elastomeric connector 122.

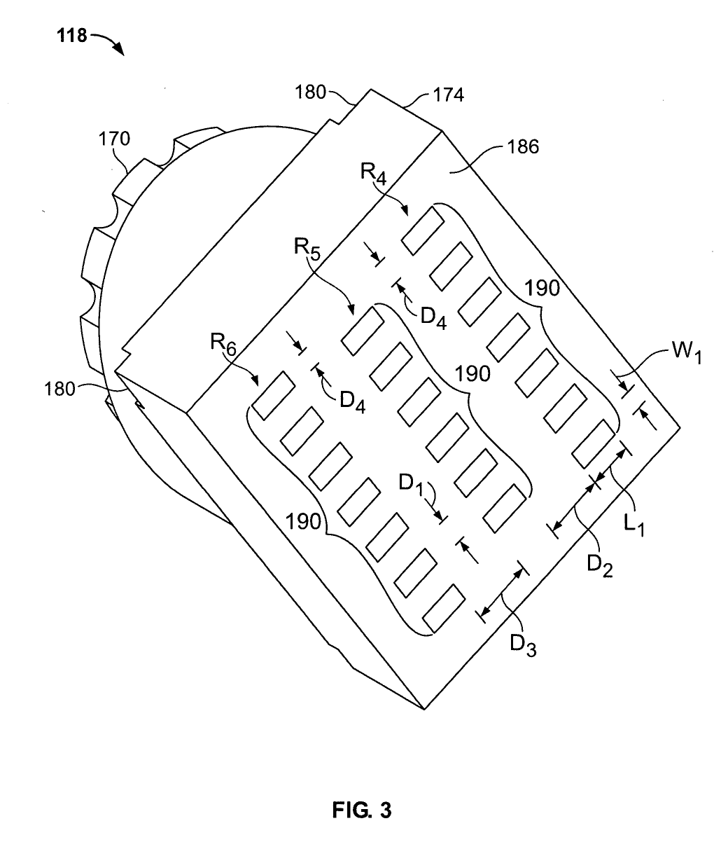

FIG. 3 is a bottom perspective view of an electronic module 118 with the elastomeric connector 122 removed. The circuit board 174 includes a lower mating surface 186 that includes a plurality of electrical contact pads 190. The contact pads 190 are arranged in a pattern that is a mirror image of the contact pattern formed on the circuit board 114. That is, the contact pads 190 are rectangular in shape and are of a uniform size wherein each contact pad 190 has a length L₁ and a width W₁ as with the contact pads 132 on the circuit board 114 (FIG. 2). In other embodiments, the contact pads 190 may be non-uniform and may include a mix of differing sizes and shapes as required to maintain the mirror image relationship with the contact pads 132 on the circuit board 114. The illustrated contact pads 190 are arranged in rows R₄, R₅, and R₆ and within each row, the pads 190 are uniformly spaced a distance D₁ apart. Rows R₄ and R₅ are spaced a distance D₂ apart and rows R₅ and R₆ are spaced apart a distance D₃ with the distances D₂ and D₃ determined by the row spacing on the circuit board 114. Row R₅ is offset a distance D₄ from rows R₄ and R₆.

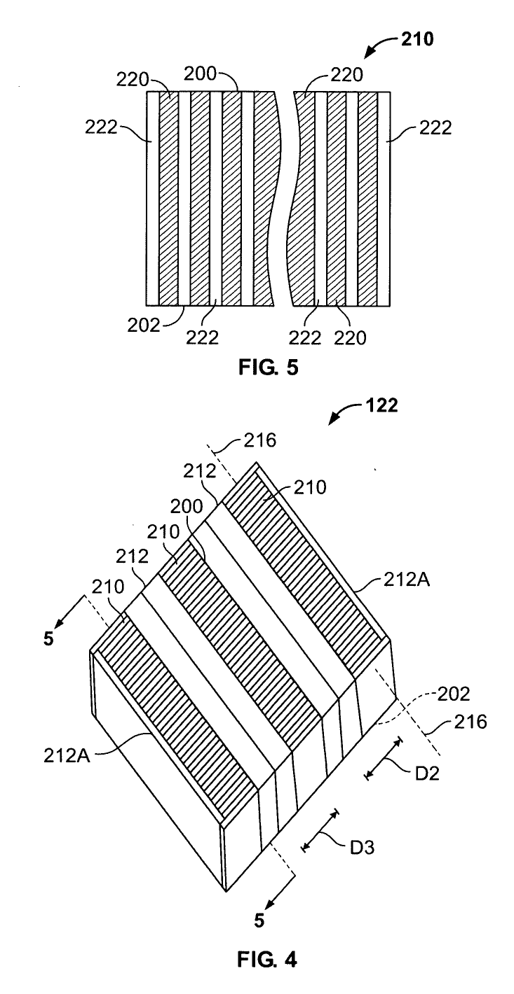

FIG. 4 is a perspective view of the elastomeric connector 122. The elastomeric connector 122 has a first or upper contact surface 200 and a second or lower contact surface 202 that is opposite the first contact surface 200. The elastomeric connector 122 is substantially rectangular in shape, although it is to be appreciated that other shapes may be formed in other embodiments. The elastomeric connector 122 includes a plurality of conductive elements 210 together with a plurality of insulation sections 212. In the illustrated embodiment, the elastomeric connector 122 includes three conductive elements 210 that are positioned to overlay the rows R₄, R₅, and R₆ of contact pads 190 on the mating surface 186 of the electronic module 118 as shown in FIG. 3.

When positioned and aligned between the circuit board 114 and the electronic module 118, the elastomeric connector 122 establishes current flow paths between the corresponding contact pads 132 and 190 on the circuit board 114 and the electronic module 118, respectively. The illustrated conductive elements 210 are rectangular in shape and are spaced distances D₂ and D₃ apart. The areas spanned by the distances D₂ and D₃ are filled with insulating sections 212. The distances D₂ and D₃ are determined by the row spacing on the circuit board 114 and the electronic module 118. In addition, insulating sections such as sections 212A may be added as appropriate to give the elastomeric connector 122 a nonconductive perimeter. Each conductive element has a longitudinal axis such as the axis 216.

FIG. 5 is a cross sectional view taken along the line 5-5 in FIG. 4 through a conductive element 210. Each conductive element 210 includes alternating conductive layers 220 and nonconductive layers 222 that extend generally parallel to one another between the upper contact surface 200 and the lower contact surface 202. The conductive layers 220 and nonconductive layers 222 extend generally perpendicular to the upper and lower contact surfaces 200 and 202, respectively, and are oriented substantially perpendicular to the longitudinal axis 216. In an alternative embodiment, however, the conductive layers 220 and nonconductive layers 222 may extend parallel to, or at an angle with respect to the longitudinal axis 216.

The nonconductive layers 222 separate the conductive layers 220, so that discrete current paths are formed through the individual conductive layers 220 between the upper and lower contact surfaces 200 and 202 enabling current flow therebetween while the nonconductive layers 222 preventing current leakage between the conductive layers 220. In an exemplary embodiment, the nonconductive layers 222 are fabricated from a known dielectric or insulating material, such as silicone rubber, and the conductive layers 200 are fabricated from a known particle filled or impregnated silicone elastomer. The conductive elements 210 may include any number of conductive layers 220 and nonconductive layers 222 as called for in a given application. Further, each conductive layer 220 may include sublayers of conductive material, and each nonconductive layer 222 may include sublayers of nonconductive material. In alternative embodiments, the conductive layers and nonconductive layers 220 and 222 may be formed into the same or different thicknesses from one another.

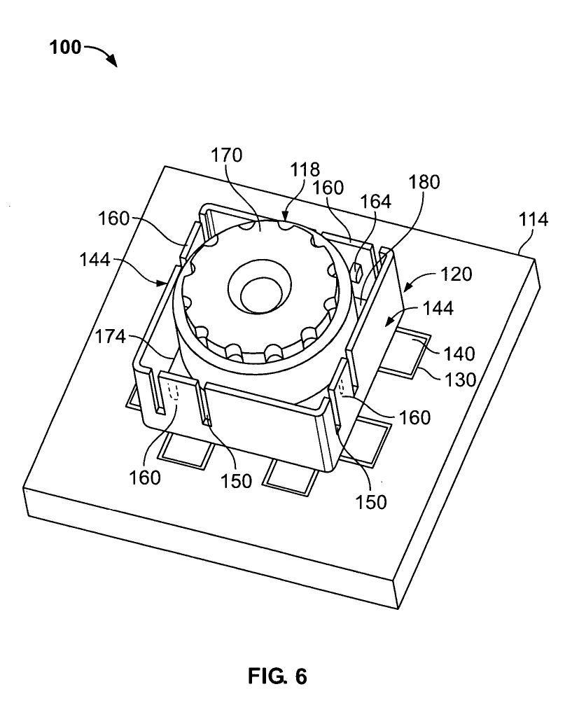

FIG. 6 is a perspective view of the electronic assembly shown in FIG. 1 in an assembled condition. The holder 120 and the elastomeric connector 122 are supplied to the manufacturer separately. The holder 120 is placed on and attached to the circuit board 114 before insertion of the electronic module 118 or the elastomeric connector 122. In an exemplary embodiment, the elastomeric connector 122 is aligned with the pad pattern on the electronic module 118 and bonded to the electronic module 118. More specifically, the upper contact surface 200 of the elastomeric connector is bonded to the electronic module 118 by applying the bonding agent only to the nonconductive or insulating sections 212 of the elastomeric connector 122. After bonding to the electronic module 118, the elastomeric connector 122 becomes an integral part of the electronic module 118.

The assembled electronic module 118 and elastomeric connector 122 are inserted into the holder 120 with the circuit board 174 on the electronic module 118 deflecting the deflectable sections 160 of the side walls 144 until the electronic module 118 passes the snap clips 164. The snap clips 164 engage the engagement areas 180 to retain the electronic module 118 in the holder 120. When the electronic module 118 is received in the holder 120, the elastomeric connector 122 is sandwiched between the electronic module 118 and the circuit board 114 and is not visible. In pressing the electronic module 118 into the holder 120 sufficiently to engage the snap clips 164, the elastomeric connector 122 is compressed and establishes an electrical connection between the circuit board 114 and the electronic module 118. Spreading the deflectable sections 160 of the side walls 144 allows for the separation and removal of the electronic module 118 from the holder 120.

The embodiments thus described provide a low cost connector assembly 110 for making component connections such as an electronic module 118 in an electronic assembly 100. The connector assembly 110 includes a holder 120 that can be reflow soldered to a circuit board 114 and an elastomeric connector 122 that has conductive elements 210 arranged in a pattern that is a mirror image to pad patterns on the circuit board 114 and the electronic module 118. The elastomeric connector is bonded to the electronic module 118 and sandwiched between the electronic module 118 and the circuit board 114 and establishes an electrical connection between the circuit board 114 and the electronic module 118. The connector assembly 110 can be easily customized with reduced tooling costs, thereby lowering manufacturing costs.

While the invention has been described in terms of various specific embodiments, those skilled in the art will recognize that the invention can be practiced with modification within the spirit and scope of the claims.

1. An electrical connector assembly comprising:
an elastomeric member comprising a plurality of elastomeric conductive elements extending between first and second contact surfaces and forming patterns on said first and second contact surfaces, one of said contact surfaces being configured to mate with an electronic module and the other of said contact surfaces being configured to mate with a circuit board; and
a holder configured to be attached to the circuit board, said holder receiving said elastomeric member, and being configured to receive and hold the electronic module securely against said elastomeric member to establish an electrical connection between the circuit board and the electronic module.

2. The connector assembly of claim 1, wherein said holder includes side walls having slots formed therein, said slots defining deflectable side wall sections.

3. The connector assembly of claim 1, wherein said holder includes deflectable side wall sections and a clip on an interior portion thereof configured to retain the electronic module.

4. The connector assembly of claim 1, wherein said holder includes side walls having slots formed therein, said slots defining deflectable side wall sections, said deflectable side wall sections being movable to receive the electronic module.

5. The connector assembly of claim 1, wherein said conductive elements comprise a plurality of conductive layers and nonconductive layers in an alternating arrangement, said conductive and nonconductive layers extending between said first and second contact surfaces.

6. The connector assembly of claim 1, wherein said conductive elements comprise a plurality of conductive layers and nonconductive layers in an alternating arrangement, said conductive and nonconductive layers extending between said first and second contact surfaces and wherein said conductive and nonconductive layers are substantially perpendicular to said first and second contact surfaces.

7. The connector assembly of claim 1, wherein the electrical connection between the circuit board and the electronic module is established through said conductive elements.

8. The connector assembly of claim 1, wherein said elastomeric member is bonded to one of the circuit board and the electronic module prior to insertion of the electronic module into said holder.

9. The connector assembly of claim 1, wherein said elastomeric member further includes insulating sections extending between said first and second contact surfaces and an adhesive applied only to said insulating sections at one of said contact surfaces to bond the elastomeric member to one of the circuit board and the electronic module.

10. The connector assembly of claim 1, wherein said plurality of conductive elements are separated from one another be a plurality of insulating sections.

11. An electronic assembly comprising:
an electronic module including a mating surface, said mating surface including a plurality of contact elements arranged in a pattern;
an elastomeric member comprising a plurality of conductive elements extending between first and second contact surfaces and forming patterns on said first and second contact surfaces, one of said contact surfaces being configured to mate with the electronic module and the other of said contact surfaces being configured to mate with a circuit board; and
a holder configured to be attached to the circuit board, said holder comprising side walls having slots formed therein that define deflectable side wall sections, said holder receiving said elastomeric member, and being configured to receive and hold the electronic module securely against said elastomeric member to establish an electrical connection between the circuit board and the electronic module.

12. The electronic assembly of claim 11, wherein said mating surface of said electronic module comprises a circuit board.

13. The connector assembly of claim 11, wherein said plurality of conductive elements are separated from one another be a plurality of insulating sections.

14. The connector assembly of claim 11, wherein said elastomeric member is bonded to one of the circuit board and said electronic module prior to insertion of said electronic module into said holder.

15. The connector assembly of claim 11, wherein said elastomeric member further includes insulating sections extending between said first and second contact surfaces and an adhesive applied only to said insulating sections at one of said contact surfaces to bond said elastomeric member to one of the circuit board and said electronic module.

16. The electronic assembly of claim 11, wherein said deflectable side wall sections are configured to engage and hold the electronic module securely against said elastomeric member.

17. The connector assembly of claim 11, wherein said holder includes a clip on an interior portion of said deflectable side wall sections to retain said electronic module.

18. The connector assembly of claim 11, said deflectable side wall sections being movable to receive said electronic module.

19. The connector assembly of claim 11, wherein said conductive elements comprise a plurality of conductive layers and nonconductive layers in an alternating arrangement, said conductive and nonconductive layers extending between said first and second contact surfaces.

20. The connector assembly of claim 11, wherein said conductive elements comprise a plurality of conductive layers and nonconductive layers in an alternating arrangement, said conductive and nonconductive layers extending between said first and second contact surfaces and wherein said conductive and nonconductive layers are substantially perpendicular to said first and second contact surfaces.
